(19) United States
(12) Patent Application Publication
(10) Pub. No.: US 2004/0160861 A1
(43) Pub. Date: Aug. 19, 2004

(54) Method and apparatus for reading from a domain expansion recording medium

(76) Inventors: Coen Adrianus Verschuren, Eindhoven (NL); Hans Willem Van Kesteren, Eindhoven (NL)

Correspondence Address: Philips Electronics North America Corporation, Corporate Patent Counsel, PO Box 3001, Briarcliff Manor, NY, 10510, US

(21) Appl. No.: 10/480,111

(22) PCT Filed: Jun. 18, 2002
(86) PCT No.: PCT/IB02/02411

(30) Foreign Application Priority Data
Jun. 19, 2001 (EP) 01202342.0

(51) Int. Cl. G11B 11/00

(52) U.S. Cl. 369/13.06

(57) ABSTRACT

The present invention relates to a method and an apparatus for reading information from a domain expansion magneto-optical recording medium, wherein the duty cycle of an external magnetic field is set so that the duration of the expanded domain in the read-out layer is longer than the duration of the domain collapse direction. A smaller bandwidth of the detection system can thus be allowed and the signal-to-noise ratio is improved. Furthermore, an additional level may be introduced for the external magnetic field between the expansion direction and the collapse direction so as to obtain an as short as possible expansion and collapse pulse. An improved resolution and SNR can thus be obtained.

The present invention relates to a method and apparatus for reading information from a magneto-optical recording medium, such as a MAMMOS (Magnetic Amplifying Magneto-Optical System) disk, comprising a recording or storage layer and an expansion or read-out layer.

In magneto-optical storage systems, the minimum width of the recorded marks is determined by the diffraction limit, i.e. by the Numerical Aperture (NA) of the focussing lens and the laser wavelength. A reduction of the width is generally based on shorter wavelength lasers and higher NA focussing optics. During magneto-optical recording, the minimum bit length can be reduced to below the optical diffraction limit by using Laser Pulsed Magnetic Field Modulation (LP-MFM). In LP-MFM, the bit transitions are determined by the switching of the field and the temperature gradient induced by the switching of the laser. For read-out of the small crescent shaped marks recorded in this way, Magnetic Super Resolution (MSR) or Domain Expansion (DomEx) methods have to be used. These technologies are based on recording media with several magneto-static or exchange-coupled RE-TM layers. According to MSR, a read-out layer on a magneto-optical disk is arranged to mask adjacent bits during reading while, according to domain expansion, a domain in the center of a spot is expanded. Because of the advantage of the domain expansion technique over MSR, bits with a length below the diffraction limit can be detected with a similar signal-to-noise ratio (SNR) as bits with a size comparable to the diffraction limited spot. MAMMOS is a domain expansion method based on magneto-statically coupled storage and read-out layers, wherein a magnetic field modulation is used for expansion and collapse of expanded domains in the read-out layer.

Thus, in the above mentioned domain expansion techniques, like MAMMOS, a written mark from the storage layer is copied to the read-out layer upon laser heating with the aid of an external magnetic field. Due to the low coercivity of this read-out layer, the copied mark will expand to fill the optical spot and can be detected with a saturated signal level which is independent of the mark size. Reversal of the external magnetic field collapses the expanded domain. A space in the storage layer, on the other hand, will not be copied and no expansion occurs.

The resolution of the MAMMOS read-out process, i.e. the smallest bit size that can be reproduced without interference from neighbouring bits, is limited by the spatial extent of the copy process, i.e. the so-called copy or detection window. This copy window decreases when the read-out laser power is reduced. On the other hand, a minimum laser power is required to enable the copy process. Thus, it is clear that the copy window should be as small as possible so as to reach a high storage density. This can be achieved by using a very localized, sharp temperature profile, for example, with high NA (Numerical Aperture) optics and shorter wave-length laser light.

Generally speaking, successful MAMMOS read-out requires a laser power larger than the minimum laser power, while interference of neighbouring bits should be avoided as this leads to additional false MAMMOS signals, i.e. so-called “double peaks”. Because long continuous mark regions lead to missing MAMMOS peaks near the center of the mark region due to a reduced stray field, small areas within the mark region with an opposite magnetization (non-mark or space regions) have been introduced as proposed e. g. in the document JP-A-2000-260079.

In the documents EP 0 913 818 A1 or EP 0 915 462 A, it is suggested to change the duty cycle of the external magnetic field to make sure that the expanded domains will be completely removed. In particular, the duration of the expansion or up direction may be chosen to be smaller than the duration of the collapse or down direction.

However, in the read-out process of a MAMMOS recording medium, a mark appears as a strong, but short signal with a duration which is typically less than 50% of the total bit period in the case of a square magnetic field. This means that a fast detection process is required and the bandwidth of the detection electronics has to be increased, leading to a deterioration of the signal-to-noise ratio (SNR). In other words, a higher density is obtained at the expense of the data rate.

It is therefore an object of the present invention to provide a method and apparatus for reading from a domain expansion recording medium of which enable improvement of the SNR.

This object is achieved by a method as claimed in claim 1 and by an apparatus as claimed in claim 12.

The increased duration of the expansion direction thus leads to an increased time available for detection and hence increases the SNR. The increase in the duration of the expansion direction or fraction for expansion is possible if the domain collapse speed which corresponds to the expansion speed is sufficiently fast, this has been demonstrated by recent simulations and experiments. Furthermore, the more stringent requirements imposed on the magnetic field coil so as to enable the required fast switching of the magnetic field can be satisfied by using e.g. thin film technology, for example, on glass or silicon sliders for producing the coils.

According to an advantageous further development, the level of the external magnetic field in the expansion direction may be changed from a copy level to a reduced stabilization level after a predetermined time period, the stabilization level being set below the copy threshold value. The stabilization level may even be set to zero level or slightly less. Furthermore, the predetermined time period may be set to be smaller than the duration of the stabilization level and/or the removal direction, preferably as short as the reading system allows according to its upper limiting frequency. The same holds for the collapse period to optimize the time for detection and hence the SNR. Thus, after a copying and expansion pulse, the magnitude of the external magnetic field is reduced to below the copy threshold but is not yet reversed or fully reversed to the opposite polarity required for the collapse of the expanded domain. During expansion, the domain wall is moved into an area with lower temperature and increased wall coercivity. When the external field is reduced to a value below the copy threshold or even switched off or slightly reversed, the higher wall coercivity in this area, together with the demagnetisation energy which tends to expand the domain, will stabilize the domain size and allow detection during a longer time. The bandwidth of the detection system can thus be reduced so as to achieve a higher SNR.

The small copy and expansion period leads to the advantage that the recording density can be improved or the copy window enlarged since the influence of neighbouring domains or bits is reduced.

Furthermore, an additional pulse-shaped magnetic field superposed on the external magnetic field in the expansion direction can be applied so as to initiate the copying step. The magnetization direction of the separate superposed pulse can be thus optimized for the copying operation. In particular, a field direction tilted along the track direction is preferred. The separate pulse can be generated by an additional coil of a dual coil configuration. The reading means of the reading apparatus may comprise this dual coil configuration for generating the external magnetic filed and the additional pulse-shaped tilted magnetic field.

The decrease of the level of the external magnetic field may also be achieved by continuously changing the external magnetic field from the copy level to the stabilization level. In this case, the continuous decrease may be an exponential decay. As an alternative, an overshoot after switching of the external magnetic field can be used to perform the copying step. Simple implementations of the dual level copy/expansion and stabilization magnetization can thus be provided.

The setting means of the reading apparatus may be arranged to perform said changing of the level of the external magnetic field.

These and other aspects of the invention are apparent from and will be elucidated with reference to the embodiments described hereinafter.

In the drawings in which:

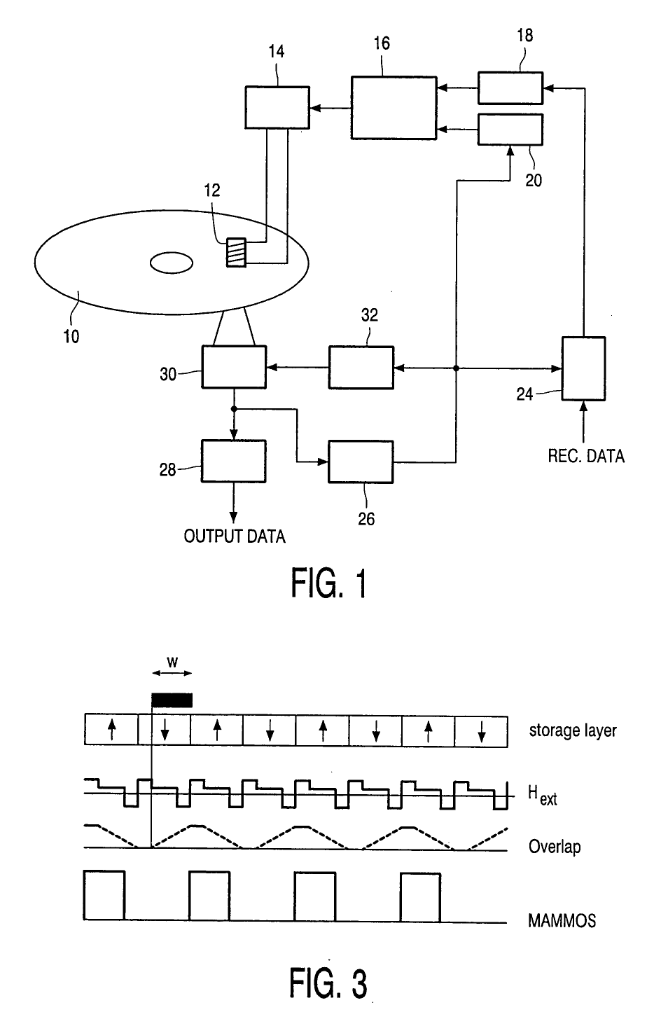

FIG. 1 shows a diagram of a magneto-optical disk player according to the preferred embodiment;

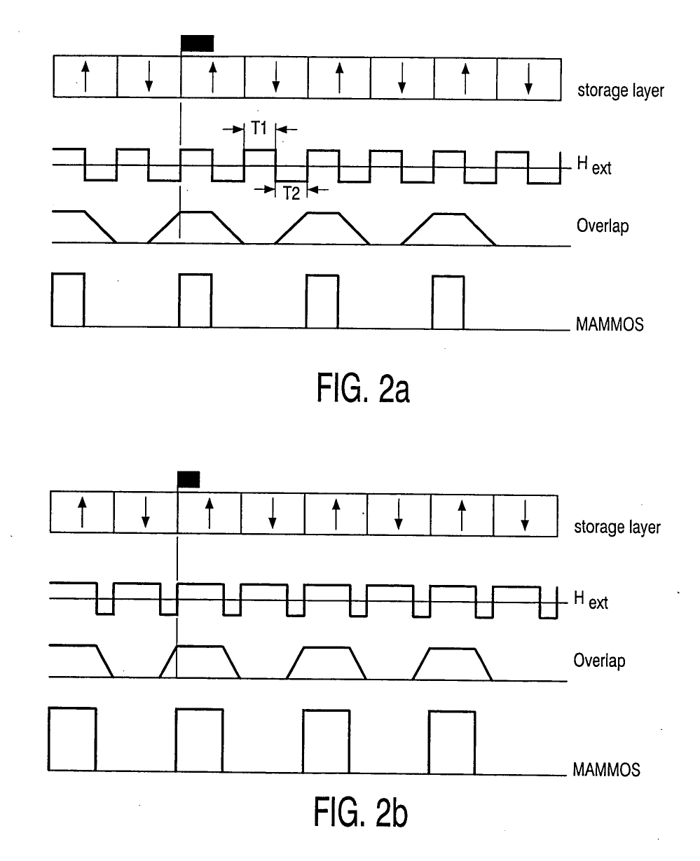

FIG. 2A shows signal diagrams for a known read-out strategy with a 50% duty cycle of an external magnetic field;

FIG. 2B shows signal diagrams for a read-out strategy with a duty cycle >50% for an expansion direction of an external magnetic field according to a first preferred embodiment;

FIG. 3 shows a read-out strategy with an external magnetic field having three different levels according to a second preferred embodiment;

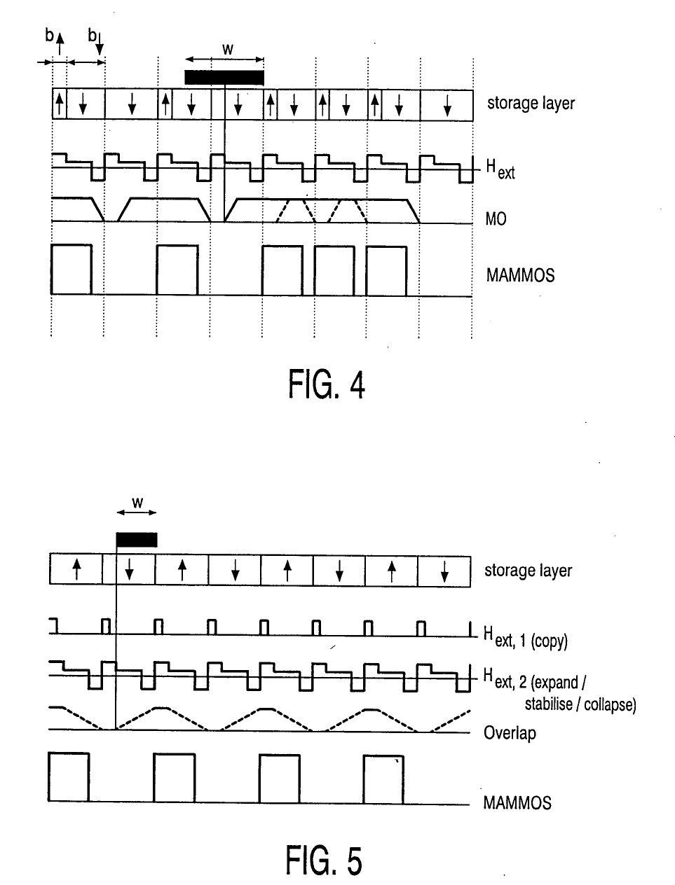

FIG. 4 shows a read-out strategy according to the second preferred embodiment wherein reduced mark regions followed by introduced space regions are used, and

FIG. 5 shows a read-out strategy according to a third preferred embodiment wherein an additional magnetic copy pulse is used.

The preferred embodiments will now be described on the basis of a MAMMOS disk player as shown in FIG. 1.

FIG. 1 shows diagrammatically the construction of the disk player. The disk player comprises an optical pick-up unit 30 having a laser light radiating section for irradiation of an magneto-optical recording medium 10, such as a magneto-optical disk, with light that has been converted, during recording, to pulses, with a period synchronized with code data, and also comprises a magnetic field applying section with a magnetic head 12 which applies a magnetic field in a controlled manner at the time of recording and playback on the magneto-optical recording medium 10. In the optical pick-up unit 30 a laser is connected to a laser driving circuit which receives recording pulses from a recording pulse adjusting unit 32 to so as control the pulse amplitude and phase of the laser of the optical pick-up unit 30. The recording pulse adjusting circuit 32 receives a clock signal from a clock generator 26 which may comprise a PLL (Phase Locked Loop) circuit.

It is to be noted that, for reasons of simplicity, the magnetic head 12 and the optical pick-up unit 30 are shown on opposite sides of the disk 10 in FIG. 1. However, according to the preferred embodiment they should be arranged on the same side of the disk 10.

The magnetic head 12 is connected to a head driver unit 14 and receives, at the time of recording, code-converted data from a modulator 24 via a phase adjusting circuit 18. The modulator 24 converts input recording data to a prescribed code.

At the time of playback, the head driver 14 receives a clock signal via a playback adjusting circuit 20 from the clock generator 26, the playback adjusting circuit 20 generating a synchronization signal for adjusting the phase and pulse amplitude applied to the magnetic head 12. A recording/playback switch 16 is provided for switching or selecting the respective signal to be supplied to the head driver 14 at the time of recording and at the time of playback.

Furthermore, the optical pick-up unit 30 comprises a detector for detecting laser light reflected from the magneto-optical recording medium 10 and for generating a corresponding reading signal applied to a decoder 28 which is arranged to decode the reading signal so as to generate output data. Furthermore, the reading signal generated by the optical pick-up unit 30 is applied to a clock generator 26 in which a clock signal is extracted from embossed clock marks of the magneto-optical recording medium 10, and which applies the clock signal for synchronization purposes to the recording pulse adjusting circuit 32, the playback adjusting circuit 20, and the modulator 24. In particular, a data channel clock may be generated in the PLL circuit of the clock generator 26.

In the case of data recording, the laser of the optical pick-up unit 30 is modulated with a fixed frequency, corresponding to the period of the data channel clock, and the data recording area or spot of the rotating magneto-optical recording medium 10 is locally heated at equal distances. Additionally, the data channel clock output by the clock generator 26 controls the modulator 24 to generate a data signal with the standard clock period. The recording data is modulated and code-converted by the modulator 24 to obtain binary runlength information corresponding to the information of the recording data.

The structure of the magneto-optical recording medium 10 may correspond to the structure described in JP-A-2000-260079.

According to the first preferred embodiment, the playback adjusting circuit 20 is arranged to set the duty cycle of the reading signal supplied via the head driver 14 to the coil of the magnetic head 12 so as to provide an increased duration of the expansion direction of the external magnetic field. Thus, the time fraction for expansion is increased to so as increase the time available for the detection process. This in turn leads to an increase of the SNR.

FIG. 2A shows a known read-out strategy with a 50% duty cycle of the external magnetic field. Thus, the duration of the expansion direction of the external magnetic field equals the duration of the collapse or removal direction of the external magnetic field. In this case the maximum allowed size of the copy window w for correct read-out equals b/2, and the time available for detection corresponds to b/2 (divided by the linear disk velocity).

Increasing the duration of the copy and expansion direction of the external magnetic field, as indicated in the diagrams of FIG. 2B, increases the time available for detection. The higher modulation frequency of the magnetic field required by the head driver unit 14 can be implemented by using thinfilm coils which have been demonstrated to work up to frequencies of a few hundred MHz. The setting of the duty cycle may be performed by corresponding analog or digital switching or by means of timer circuits provided in the playback adjusting circuit 20.

FIG. 3 shows a read-out strategy according to a second preferred embodiment wherein an external magnetic field with three levels is used. After a comparatively short copying and expansion period exp at a copy level, the magnitude of the external field is reduced to a second level, i.e. a stabilization level, which is below the copy threshold but not yet reversed to the opposite polarity required for the collapse of the expanded domain. It is to be noted that the stabilizing magnetic field may even be reduced to zero level or slightly below that, i.e. it may even be switched off or slightly reversed, since the higher wall coercivity in the lower temperature zone with the demagnetization energy will stabilize domain size and allow the detection for a longer period of time. After the stabilization period at the stabilization level, a short collapse pulse of a duration coll with a sufficient level of opposite polarity or opposite magnetization direction is applied as an initialization for the MAMMOS detection of a subsequent mark. The expansion and collapse pulse can thus be kept as short as possible so as to obtain the highest resolution and SNR, since influences of neighbouring domains can be reduced. However, the duration of the expansion and collapse should be sufficiently long to allow full expansion and collapse of the domain in the read-out layer.

FIG. 3 shows a storage layer with the recorded marks and an indicated copy window w of a size which is sufficiently small to prevent any influence of adjacent domains. This is indicated by the overlap signal MO (a convolution of the moving copy window and the stray field of the bits in the storage layer), which shows no overlapping areas there is no additional unwanted expansion in the MAMMOS signal either. In this case, the time available for detection is increased as well as the maximum allowed size of the copy window w as compared to the diagrams in the FIGS. 2A and 2B.

FIG. 4 shows another diagram relating to the same read-out strategy as in FIG. 3, wherein a mark is recorded in the storage layer as a sequence of a short mark portion b↑ followed by a longer space or subspace portion b↓. According to this write strategy, even long mark regions comprising a plurality of bits can be detected due to an increased stray field in the center of the long mark region and the possibility of an even larger copy window w. This can be achieved due to the short expansion duration and collapse duration achieved by way of the three levels of the external magnetic field in combination with the write strategy where each mark channel bit of length b is composed of a small mark portion b↑ and a longer space portion b↓.

Generally speaking, the following rules can be used to calculate the improvement in copy window (directly related to power margin), resolution and time available for detection:

wₘₐₓ=b+b↓−exp=2b−b↑−exp,

wherein wₘₐₓ denotes the maximum length of the copy window and exp denotes the expansion time (multiplied by the disk velocity v to obtain the corresponding length) during which the external field is sufficiently large to nucleate and expand a bit from the storage layer into the read-out layer. The minimum channel bit length can be calculated as follows:

bₘᵢₙ=[w+b↑+exp]/2.

The detection time is then given by:

detection=[b−coll]/v=[exp+stab]/v,

where coll is the collapse time (multiplied by the disk velocity v to obtain the corresponding length) and stab is the duration of the stabilizing field (multiplied by the disk velocity v to obtain the corresponding length).

FIG. 5 shows a signalling diagram of a read-out strategy according to a third preferred embodiment wherein an additional pulse-shaped external magnetic field is applied to initiate or perform the copying process of the mark from the storage player to the read-out layer. For expansion, stabilization and collapse of the domain in the read-out layer, an external magnetic field with a direction perpendicular to the recording medium 10 is optimum. However, it has been shown that, a magnetic field direction tilted along the track direction of the recording medium 10 is preferred for copying. Therefore, the magnetic head 12 may be arranged as a dual coil configuration to generate a separate “nucleation” pulse for copying a domain into the read-out layer. The generation of this additional magnetic pulse can be controlled by the head driver unit 14 wherein the introduction of the additional stabilization level is performed in the playback adjusting circuit 20, that is, by a corresponding level switching circuit which may be controlled by an analog or digital timer function.

Thus, as indicated in FIG. 5, the pulse-shaped and preferably tilted copy field H_{ext,1} is applied to copy the mark into the read-out layer, while the preferably perpendicular magnetic field H_{ext,2} is used to expand, stabilize and collapse the domain in the read-out layer.

It is to be noted that the separated copying/expanding and stabilization functions of the external magnetic field described in the second and third embodiment may as well be implemented by other signal wave-forms. In practice, the slopes of the pulses will not be infinitely steep as shown in the pictures, but have limited rise times due to the self-inductance of the coil of the magnetic head 12. One way to implement the expand/stabilize combination may be the use of a pulse shape with a continuously decreasing magnitude, such as a more or less exponentially decreasing magnitude, from the copy/expand level down to the stabilization level. Another implementation may be the use of an expand/stabilize pulse with an overshoot after switching on which suffices for copying and expansion.

Furthermore, it is to be noted that the implementation of the preferred embodiments may also require a modification of the coil of the magnetic head 12 and the hardware of the head driver unit 14 so as to generate appropriate field pulses, thus improving the results derived from better optics, stack designs and the like.

Thus, the present invention provides the advantage that the signal-to-noise ratio is improved due to the fact that the detection time is increased and a smaller detection band width can be used. The demands on and hence the costs of the detection electronics are thus reduced.

The present invention can be applied to any reading system for a domain expansion recording medium where an alternating external magnetic field is applied to expand and collapse a domain in the read-out layer. The preferred embodiments may thus vary within the scope of the attached claims.

1. A method of reading information from a magneto-optical recording medium (10), comprising a storage layer and a read-out layer, said method comprising the steps of:
copying a written mark from said storage layer to said read-out layer upon laser heating with the aid of an external magnetic field, thus forming an expanded domain in said read-out layer;
removing said expanded domain from said readout layer by reversing the direction of said external magnetic field, and
setting the duty cycle of said external magnetic field so that the duration of the expanded domain in the read-out layer is longer than the duration of the removal direction.

2. A method as claimed in claim 1, which method also comprises the step of changing the level of said external magnetic field from a copy or expand level to a reduced stabilization level after a predetermined time period, said stabilization level being set below the copy threshold value.

3. A method as claimed in claim 2, wherein said stabilization level is set to zero level or below that level.

4. A method as claimed in claim 2 or 3, wherein said predetermined time period is set according to the upper limiting frequency of the reading system.

5. A method as claimed in any one of claims 2 to 4, wherein said duration of said removal direction is set according to the upper limiting frequency of the reading system.

6. A method as claimed in any one of claims 1 to 5, wherein the time available for detection in relation to bit length and duration of removal direction is determined according to the following equation:
det=(b−coll)/v,
wherein det denotes said time available for detection, b denotes said bit length, and coil denotes the duration of the removal direction (multiplied by the disk velocity v to obtain the corresponding length).

7. A method as claimed in any one of claims 2 to 6, wherein said predetermined period is set according to the following equation:
expₘₐₓ=2bₘᵢₙ−b↑−wₘₐₓ,
wherein expₘₐₓ denotes the maximum value of said predetermined period, bₘᵢₙ denotes the minimum bit length on said magneto-optical recording medium (10), wₘₐₓ denotes the maximum spatial size of the copy window, and b↑ denotes the length of said written mark.

8. A method as claimed in any one of the preceding claims, which method also comprises the step of applying an additional pulse-shaped magnetic field superposed on said external magnetic field in said expansion direction so as to initiate said copying step.

9. A method as claimed in claim 1 or 2, which method also comprises the step of changing the level of said external magnetic field so as to continuously decrease from a copy level to a reduced stabilization level, said stabilization level being set below the copy threshold value.

10. A method as claimed in claim 9, wherein said continuous decrease is an exponential decay.

11. A method as claimed in claim 1 or 2, which method also comprises the step of using an overshoot after the switching of said external magnetic field to perform said copying step.

12. A reading apparatus for reading information from a magneto-optical recording medium (10) comprising a storage layer and a read-out layer, said apparatus comprising:
reading means (12, 30) for copying a written mark from said storage layer to said read-out layer upon laser heating with the aid of an external magnetic field, thus forming an expanded domain in said read-out layer, and for removing said expanded domain from said read-out layer by reversing the direction of said external magnetic field, and
setting means (20) for setting the duty cycle of said external magnetic field so that the duration of the expanded domain in the read-out layer is longer than the duration of the removal direction.

13. A reading apparatus as claimed in claim 12, wherein said setting means (20) are arranged to change the level of said external magnetic field from a copy level to a reduced stabilization level after a predetermined time period, said stabilization level being set below the copy threshold value.

14. An apparatus as claimed in claim 12 or 13, wherein said reading means comprises a dual-coil configuration (12) for generating said external magnetic field and an additional pulse-shaped magnetic field for initiating said copying process.

15. An apparatus as claimed in claim 14, wherein said additional pulse-shaped magnetic field is tilted with respect to the normal on said recording medium.

16. An apparatus as claimed in any one of claims 10 to 15, wherein said reading apparatus is a disk player for MAMMOS disks.
